(19) United States
(12) Patent Application Publication
(10) Pub. No.: US 2020/0072037 A1
(43) Pub. Date: Mar. 5, 2020

(54) BOREHOLE SURVEY INSTRUMENT AND METHOD

(71) Applicant: Gyro Technologies Limited, Gloucestershire (GB)

(72) Inventor: Nicholas Peter Wallis, Eckington (GB)

(21) Appl. No.: 16/557,858

(22) Filed: Aug. 30, 2019

(30) Foreign Application Priority Data
Aug. 31, 2018 (GB) 1814179.6

(51) Int. Cl. E21B 47/022; G01C 19/02

(52) U.S. Cl. CPC E21B 47/022; G01C 19/02

(57) ABSTRACT

A method and apparatus for collecting borehole survey data indicative of geometry of a borehole, using a borehole survey instrument comprising at least one rate sensor and an inclination sensor. The borehole survey instrument is dropped into the borehole, such that the borehole survey instrument freefalls to a bottom of the borehole, and out run data, indicative of azimuth and inclination of the borehole, is continuously measured using the at least one rate sensor, and the inclination sensor, as the borehole survey instrument is removed from the borehole.

### TECHNICAL FIELD

This invention relates to borehole survey instruments and methods of using borehole survey instruments.

### BACKGROUND

When conducting borehole surveys it is desired to accurately track the path of a previously drilled borehole. This typically involves taking measurements along the length of the borehole, which provide information on the angle of the borehole with respect to north (azimuth), the inclination of the borehole and the distance along (or depth of) the borehole. The combination of these measurements enables a complete three dimensional map of the borehole to be constructed. The collection of data indicative of some, or all, of these measurements is referred to as a “survey”.

Typically, inclination of the borehole is derived using measurements taken by accelerometers or inclinometers and the azimuth angle is derived using measurements taken from gyro sensors. These sensors are located inside a single borehole survey instrument package constructed to fit into the narrow diameter of the borehole.

When performing such surveys it is common to deploy the survey instrument by attaching it to a cable. This allows the borehole survey instrument to be conveyed into and out of the borehole in a controlled manner. Where the cable is a wireline, electrical connections between the borehole survey instrument and the surface enable the communication of signals to and from the instrument to control the functionality. The wireline may also provide power.

In alternative arrangements, a slickline connection is used to control the descent and ascent of the instrument, but does not provide electrical connections. In this instance the power is provided by a battery within the borehole survey instrument and the data collected during the survey is stored in an on-board memory module.

Gyrocompass measurements are typically performed at fixed stationary locations along the length of the borehole as the instrument is deployed under the control of the cable. The depth of the individual gyrocompass survey points is conveniently obtained by measuring the length of cable deployed from the surface.

Surveys may be performed both as the instrument is lowered and again as it is lifted back to the surface. This enables two surveys to be taken, one as the instrument is lowered, usually referred to as an in run survey, and one as it is lifted, which is referred to as an out run survey. These can be compared for quality control purposes or additional statistical analysis.

A significant limitation of the above survey procedure is the time expended in lowering and recovering the instrument which interrupts the drilling process. One method used to mitigate this is to perform a drop survey. This involves inserting the instrument into the borehole at the surface and then allowing it to freefall to the bottom of the borehole. Gyrocompass measurements are then taken as the survey instrument is removed from the borehole in stages, as the drill string is recovered. The time taken to reach the bottom of the borehole is significantly reduced compared to the time taken when performing an in run survey on a wireline, as described above. However, a significant disadvantage of this method is that, due to the continuous motion on the in run, gyrocompass measurements are not possible during the drop and therefore only out run survey data is measured.

The gyrocompassing procedure for performing azimuth and inclination measurements during an out run survey is well known and typically requires the instrument to be stationary during the measurement duration, which may take several minutes to complete. These measurements can conveniently be performed when the drill string is withdrawn from the borehole which may be done, for example, when the drill bit requires replacement. During this process, for operational reasons, the drill string is typically removed in sections of approximately ^{˜}10 metres length. The sections of the drill string may be referred to throughout the specification as drill rods or drill pipes. The drill rods are removed by the drill rig at the surface and during the time between removal of adjacent drill rods, the borehole survey instrument will be stationary within the borehole. This provides a time window during which a gyrocompass measurement may be conveniently conducted.

However it is important to ensure that sufficient time has elapsed to allow the gyrocompass step to complete before proceeding with the removal of the next section of the drill string. This typically requires the drill string to be stationary for a period which is longer than the time required to remove the string section and consequently the overall operational time is undesirably elongated.

The exact number and length of the drill rods deployed in the borehole is known and therefore the exact distance of the instrument along the length of the hole is known for each section of the drill string that is removed. The data recorded by the instrument is downloaded and processed when the survey instrument is recovered on the surface at the end of the survey.

This method therefore provides a series of discrete measurements of the inclination and azimuth angle of the borehole along its length. The path of the borehole between these points is extrapolated using assumptions on the practical limitations on the possible deviation over the ^{˜}10 m span between known survey points. A three dimensional map of the borehole may therefore be computed by analysing the entire data set. A disadvantage of this method however is that any deviations or micro-tortuosity between discrete survey points cannot be measured using this survey method in isolation.

It is an object of the invention to provide a borehole survey instrument and method which overcomes disadvantages associated with the prior art.

### SUMMARY

According to the invention in one aspect, there is provided a method for collecting borehole survey data indicative of geometry of a borehole, using a borehole survey instrument comprising at least one rate sensor and an inclination sensor, the method comprising dropping the borehole survey instrument into the borehole, such that the borehole survey instrument freefalls to a bottom of the borehole, and continuously measuring out run data indicative of azimuth and inclination of the borehole, using the at least one rate sensor, and the inclination sensor, as the borehole survey instrument is removed from the borehole.

Continuous measurement of data during the out run provides an opportunity to obtain an independent out run survey more quickly than using conventional gyrocompassing techniques. Gyrocompassing on the out run requires the borehole survey instrument to be stationary during removal of the borehole survey instrument for 30-60 seconds at each point at which a measurement is taken; this is a longer period of time than the borehole survey instrument would typically be stationary for during removal. By utilising continuous measurement techniques, additional time is not needed beyond the time typically taken to remove the borehole survey instrument from the borehole. As such, operational efficiency is improved.

Optionally, the method further comprises repeatedly pausing removal of the borehole survey instrument; and measuring, using an output of the at least one rate sensor, a drift rate of the at least one rate sensor when the borehole survey instrument is stationary.

Optionally, the method further comprises correcting the data indicative of azimuth measured by the rate sensor using the measured drift rate.

Optionally the method further comprises determining whether the borehole survey instrument is stationary using the at least one rate sensor and the inclination sensor.

Optionally, a stable output from at least one of the at least one rate sensor and the inclination sensor indicates that the borehole survey instrument is stationary.

Optionally, the drift rate of the at least one rate sensor is measured without gyrocompassing.

Optionally, the drift rate of the at least one rate sensor is measured for a period of 30 seconds or less.

Optionally, the method further comprises continuously measuring in run data indicative of azimuth and inclination of the borehole, using the at least one rate sensor and the inclination sensor, as the borehole survey instrument freefalls to the bottom of the borehole.

Optionally, the method further comprises validating one of the in run data and the out run data using the other of the in run data and the out run data to provide a validated borehole survey.

Optionally, the method further comprises using the in run data and the out run data to produce two continuous borehole surveys, each providing the azimuth and the inclination of the borehole.

Optionally, the method further comprises continuously recording accelerometer data using the inclination sensor, as the borehole survey instrument freefalls to the bottom of the borehole, detecting points during the freefall at which a change in accelerometer data is greater than a threshold during a threshold time period, the points indicative of a pipe joint in a drill string of the borehole, and calculating depth data associated with the data indicative of azimuth and inclination based on the detected points of the borehole survey instrument during the freefall.

Optionally, the borehole survey instrument further comprises a magnetometer and the method further comprises continuously recording magnetic data using the magnetometer, as the borehole survey instrument freefalls to the bottom of the borehole, detecting points during the freefall at which a change in output of the magnetometer is greater than an magnetometer threshold during a threshold time period, the points indicative of a pipe joint in a drill string of the borehole, and calculating depth data associated with the data indicative of azimuth and inclination based on the detected points of the borehole survey instrument during the freefall.

Optionally, the method further comprises continuously recording, as the borehole survey instrument freefalls to the bottom of the borehole, in run pressure data indicative of a pressure of a fluid within the borehole, continuously recording out run pressure data indicative of the pressure of the fluid within the borehole and collecting out run depth data indicative of depth of the borehole, as the borehole survey instrument is removed from the borehole, and correlating the out run depth data and out run pressure data with the in run pressure data to provide in run depth data.

According to the invention in a further aspect, there is provided a borehole survey instrument for collecting borehole survey data indicative of geometry of a borehole and for dropping into the borehole such that the borehole survey instrument freefalls to a bottom of the borehole, the borehole survey instrument comprising: at least one rate sensor configured to collect data indicative of azimuth of the borehole and an inclination sensor configured to collect data indicative of inclination of the borehole, wherein the at least one rate sensor and the inclination sensor are configured to continuously measure the azimuth and the inclination as the borehole survey instrument is removed from the borehole.

Optionally, the one or more rate sensors are MEMS gyro sensors with a bias stability level of substantially 1 degree per hour or less.

Optionally, the borehole survey instrument further comprises a controller, wherein the controller is configured to determine a drift rate of the one or more rate sensors using the output of the at least one rate sensor when the borehole survey instrument is stationary.

Optionally, the controller is further configured to determine whether the borehole survey instrument is stationary using the output of the at least one rate sensor and the inclination sensor.

Optionally, the controller is configured to determine the drift rate of the at least one rate sensor without using data collected by the at least one rate sensor by gyrocompassing.

Optionally, the at least one rate sensor and the inclination sensor are further configured to continuously measure, as the borehole survey instrument freefalls to the bottom of the borehole, in run data indicative of azimuth and inclination of the borehole.

The same rate sensor may be used to collect data indicative of azimuth during the in run and the out run. The same inclination sensor may be used to collect data indicative of inclination during the in run and the out run.

Optionally, the inclination sensor is further configured to continuously record acceleration data as the borehole survey instrument freefalls to the bottom of the borehole, the acceleration data indicative of depth of the borehole.

Optionally, the borehole survey instrument further comprises a magnetometer configured to continuously record data as the borehole survey instrument freefalls to the bottom of the borehole, the data indicative of depth of the borehole.

Optionally, the borehole survey instrument further comprises a pressure sensor configured to collect pressure data indicative of a pressure of a borehole fluid within the borehole.

Optionally, a sensing portion of the pressure sensor is enclosed in a compartment comprising a fluid inlet to expose the pressure sensor to the borehole fluid, and wherein a portion of the pressure sensor comprising electronic components is sealed within a borehole survey instrument housing to prevent ingress of the fluid.

Optionally, the borehole survey instrument comprises a first rate sensor configured to collect the in run data and the out run data in substantially vertical portions of the borehole and a second rate sensor configured to collect the in run and the out run data in substantially horizontal portions of the borehole.

According to the invention in a further aspect there is provided a method for determining a depth of a borehole survey instrument within a borehole, the borehole survey instrument comprising a pressure sensor, an inclination sensor and at least one rate sensor, wherein the borehole survey instrument is configured to collect data on an in run as the borehole survey instrument falls to a bottom of the borehole, and the borehole survey instrument is configured to collect data on an out run as the borehole survey instrument is removed from the borehole during recovery of drill rods of known lengths, the method comprising: dropping the borehole survey instrument into the borehole, such that the borehole survey instrument freefalls to a bottom of the borehole, continuously measuring, as the borehole survey instrument freefalls to the bottom of the borehole, in run pressure data indicative of a pressure of a fluid within the borehole, and in run data comprising azimuth data and inclination data indicative of an azimuth and an inclination of the borehole, continuously measuring during the out run, out run pressure data indicative of the pressure of the fluid within the borehole and out run data comprising azimuth data and inclination data indicative of an azimuth and an inclination of the borehole, stopping movement of the borehole survey instrument as each drill rod is recovered and using the known length of each drill rods to derive out run depth data when the borehole survey instrument is stationary, and correlating the out run depth data and out run pressure data with the in run pressure data to provide in run depth data.

Optionally, at each position in which the out run depth data is derived, an associated out run pressure measurement is determined, and wherein in run pressure measurements equal in value to the associated out run pressure measurements are assigned an in run depth measurement equal to an out run depth measurement associated with the corresponding out run pressure measurement.

### BRIEF DESCRIPTION OF THE DRAWINGS

Specific embodiments of the invention will now be described, by way of example only, with reference to the accompanying drawings in which:

FIG. 1 is a schematic representation of a borehole survey instrument according to an embodiment of the invention,

FIG. 2 is a schematic representation of a controller,

FIG. 3 is a representation of the output of a gyro sensor as the gyro sensor is rotated about the longitudinal axis of a borehole survey instrument,

FIG. 4 is a representation of the measurement of the earth's horizontal rate at a latitude λ,

FIG. 5 is a plot showing an output of an accelerometer along a longitudinal axis of a borehole survey instrument according to the invention, as the borehole survey instrument is removed from a borehole

FIG. 6 is a plot showing an output of an accelerometer along a radial axis of a borehole survey instrument according to the invention, as the borehole survey instrument is removed from a borehole

FIG. 7 is a plot showing the rotation rate of a borehole survey instrument according to the invention about a longitudinal axis, as the borehole survey instrument is removed from a borehole,

FIG. 8 is a plot showing an output of a magnetometer along a longitudinal axis of a borehole survey instrument according to an embodiment of the invention during an in run,

FIG. 9 is a plot showing an output of a magnetometer along a radial axis of a borehole survey instrument according to an embodiment of the invention during an in run,

FIG. 10 is a plot showing an output of an accelerometer along a longitudinal axis of a borehole survey instrument according to the invention, as the borehole survey instrument falls within a borehole,

FIG. 11 is a plot showing an output of an accelerometer along a radial axis of a borehole survey instrument according to the invention, as the borehole survey instrument falls within a borehole,

FIG. 12 shows a borehole survey instrument according to a further embodiment of the invention.

FIG. 13 is a plot showing an output of a pressure sensor of a borehole survey instrument according to the embodiment of FIG. 12, as the borehole survey instrument falls within a borehole, and

FIG. 14 is a plot showing an output of a pressure sensor of a borehole survey instrument according to the embodiment of FIG. 12, as the borehole survey instrument is removed from a borehole.

### DETAILED DESCRIPTION

Generally disclosed herein are borehole survey instruments and methods of using borehole survey instruments to take continuous measurements of azimuth and inclination of a borehole during an out run of the borehole survey instrument (that is, as the borehole survey instrument is removed from the borehole). Borehole survey instruments according to an embodiment of the invention are drop borehole survey instruments. That is, the borehole survey instrument is configured to be dropped into the borehole and to freefall within a drill string of the borehole, typically landing on top of a drill bit within the bottom hole assembly. It should be understood that the term “freefall” encompasses the borehole survey instrument falling within the borehole without support from a cable or slickline. The borehole survey instrument may however comprise mechanisms in order to provide some drag and control the descent of the borehole survey instrument within the borehole. For example, the borehole survey instrument may comprise parachutes, buoyancy aids or traverse disks which induce turbulence, to control the rate of descent of a survey instrument. The borehole survey instrument is dropped into the borehole without the use of cables or slicklines. As the drill string is withdrawn from the borehole in sections, the borehole survey instrument is removed along with the drill bit. The borehole survey instrument is configured to continuously measure out run data indicative of azimuth and inclination of the borehole, using a rate sensor and an inclination sensor, as the borehole survey instrument is removed with the drill tool.

It will be appreciated that the path of borehole survey instrument through the borehole as it is inserted and removed, is necessarily identical. This presents the opportunity for survey measurements to be performed during both an in run (as the instrument is dropped into the borehole) and an out run (as the instrument is removed from the borehole) and for the in run survey and the out run survey to be used for validation, for example.

The borehole survey instrument may be configured to continuously measure in run data indicative of azimuth and inclination of the borehole as the borehole survey instrument falls within the borehole. The in run data may be compared to the out run data collected during removal of the instrument for quality control purposes. Alternatively, the in run data may be used in combination with the out run data to enhance the reliability and accuracy of the overall survey. In a specific arrangement, one of the in run and out run survey may be used to validate the other of the in run and out run survey to provide a validated borehole survey. That is, one of the in run and out run survey may be used as evidence of the accuracy of the other of the in run and out run survey, therefore providing a validated survey that has been verified by one of the in run and out run. The in run and out run data may be stored in a memory of the borehole survey instrument and the comparison may occur once the borehole survey instrument is recovered from the borehole.

In order to continuously measure the in run data as the borehole survey instrument falls within the borehole, alternative methods may be employed for surveying for two reasons. Firstly, the borehole survey instrument is in constant motion between the time that it is dropped until it reaches the bottom of the borehole and secondly, in the absence of a wireline or slickline, alternative techniques for deriving measurements of the depth of the borehole may be employed. These techniques are discussed in more detail below.

An example of a borehole survey instrument, gyrocompassing techniques and continuous measurement techniques utilised by the invention to determine the azimuth is given below.

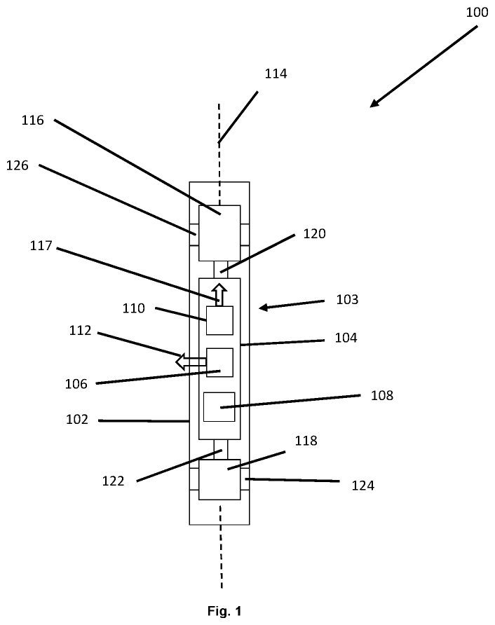

FIG. 1 shows a schematic representation of a borehole survey instrument 100. The borehole survey instrument 100 may be a drop borehole survey instrument configured to freefall through a borehole. The borehole survey instrument 100 may be operable in a gyrocompass mode to perform gyrocompassing surveys and a continuous mode to perform continuous surveys (continuous surveys are explained further below).

The borehole survey instrument 100 is generally cylindrical in cross section. The diameter of the borehole survey instrument 100 may be preferably less than 45 mm to allow insertion within a typical borehole drill string diameter, such as that found in the oil and gas industry.

The borehole survey instrument 100 comprises a housing 102. Enclosed within the housing is a sensor module system 103 comprising a sensor module support 104 and at least one sensor. The sensor module system 103 comprises two rate sensors 106, 110 and an inclination sensor 108. The rate sensors 106, 110 may be gyro sensors and the inclination sensor 108 may be an accelerometer. Other examples of rate sensors and inclination sensors may be provided. In general, the sensor module system 103 may comprise at least one rate sensor and may comprise at least one inclination sensor.

In FIG. 1, the sensing axis 112 of a first gyro sensor 106 is perpendicular to a longitudinal axis 114 of the borehole survey instrument 100. The gyro sensor 106 may be suitable for gyrocompassing in substantially vertical boreholes, where the horizontal earth rate components are derived from measurements taken as the sensing axis 112 of the gyro sensor 106 is rotated around a longitudinal axis 114 of the borehole survey instrument. In FIG. 1, a sensing axis 117 of a second gyro sensor 110 is aligned to the longitudinal axis 114 of the borehole survey instrument 100.

The borehole survey instrument 100 further comprises a rotation drive means 116, and a bearing 118. The sensor module system 103 is coupled to the rotation drive means 116 via a drive shaft 120 such that when the rotation drive means 116 is actuated, the sensor module system 103 is freely rotatable around the longitudinal axis 114 of the survey instrument through 360°. Alternative arrangements may be utilised to provide the capability of rotating the sensor module system 103 through 360° about the longitudinal axis 114.

In the borehole survey instrument 100, the sensor module system 103 is coupled to a support shaft 122, fixed within the rotational bearing 118. The bearing 118 and the rotational drive means 116 are rigidly fixed to the housing 102 via attachments 124 and 126 respectively.

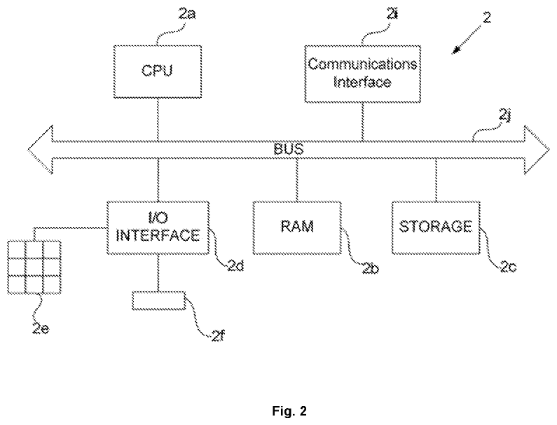

The borehole survey instrument 100 may further comprise a controller 200 (as shown schematically in FIG. 2). The data analysis and switching between the gyrocompass mode and the continuous mode is performed under the control of the controller 200, which may be a computing system.

FIG. 2 schematically illustrates components of an exemplary controller 200 in accordance with an embodiment of the borehole survey instrument 100, although other variations may be envisaged by those skilled in the art.

The controller 200 comprises a CPU 2a which is configured to read and execute instructions stored in a RAM memory 2b which may be a volatile memory. The RAM 2b stores instructions for execution by the CPU 2a and data used by those instructions. For example, instructions may be provided to control switching between a gyrocompass mode and a continuous mode based on elapsed time or the analysis of data derived from the various sensors within the borehole survey instrument 100.

The controller 200 further comprises non-volatile storage 2c, such as, for example, flash memory, although it will be appreciated that any other form of non-volatile storage may be used. Computer readable instructions for controlling the rotation of rotation drive means 208 may be stored in the non-volatile storage 2c. The controller 200 further comprises an I/O interface 2d to which peripheral devices used in connection operation of the borehole survey instrument 100 may be connected. For example, an input 2e (shown in the form of a keypad) may be provided to allow user interaction with instrument to initiate surveys or download survey data, such as in run data and out run data. While not shown, it will be appreciated that other input or output devices may be connected to the I/O interface, such as a display. In other embodiments, however, Interaction with the borehole survey instrument 100 may be entirely through a connected device.

The I/O interface 2d may further comprise a port 2f to allow the connection of I/O devices, such as data storage devices. For example, the port 2f may be a USB port to allow connection of USB flash drives. A communications interface 2i may also be provided. The communications interface 2i may provide for short range connections to other devices (e.g. via Bluetooth, near-field communication (NFC), etc.), and/or for connection to networks such as the Internet, for longer range communication. The CPU 2a, RAM 2b, non-volatile storage 2c, I/O interface 2d and communications interface 2i are connected together by a bus 2j.

It will be appreciated that the arrangement of components illustrated in FIG. 2 is merely exemplary, and that the controller 200 may comprise different, additional or fewer components than those illustrated.

While references have been made herein to a controller or controllers it will be appreciated that control functionality described herein can be provided by one or more controllers. Such controllers can take any suitable form. For example, control may be provided by one or more appropriately programmed microprocessors (having associated storage for program code, such storage including volatile and/or non-volatile storage). Alternatively or additionally control may be provided by other control hardware such as, but not limited to, application specific integrated circuits (ASICs) and/or one or more appropriately configured field programmable gate arrays (FPGAs).

The outputs obtained from the gyro sensors 106 and 110 and/or the inclination sensor 108 may be fed back to the controller 200. The controller 200 may be configured to utilise the outputs obtained from one or more of the gyro sensors 106 and 110 and/or the inclination sensor 108 in order to determine, for example, whether the borehole survey instrument is stationary, or whether the output of the gyro sensor 106 and 110 is indicative of a drift rate of the gyro sensor 106 or 110, or a rate of change of azimuth of the borehole survey instrument 100. The method for determining whether the borehole survey instrument is stationary and whether the output of the gyro 106 and 110 is indicative of drift rate is explained in detail below.

As discussed above, the borehole survey instrument 100 may be used in a gyrocompassing mode in order to measure data indicative of an azimuth of the borehole. An example method of gyrocompassing is given below, with reference to the borehole survey instrument of FIG. 1.

When using the borehole survey instrument 100 in a borehole with an inclination substantially vertical or close to vertical, rotation of the rate sensor about the longitudinal axis provides an accurate indication of the horizontal component of the earth rotation at any given angular position. As the borehole approaches the horizontal, rotation about the longitudinal axis will sense primarily the variation in the vertical earth component, since the sensing axis is likely to be aligned in a substantially upward or downward direction, with reduced sensitivity to the variation in the horizontal earth rotation rate. The accuracy therefore decreases as the angle from vertical increases and the borehole survey instrument is practically operable up to a limit of around 70 degrees from vertical.

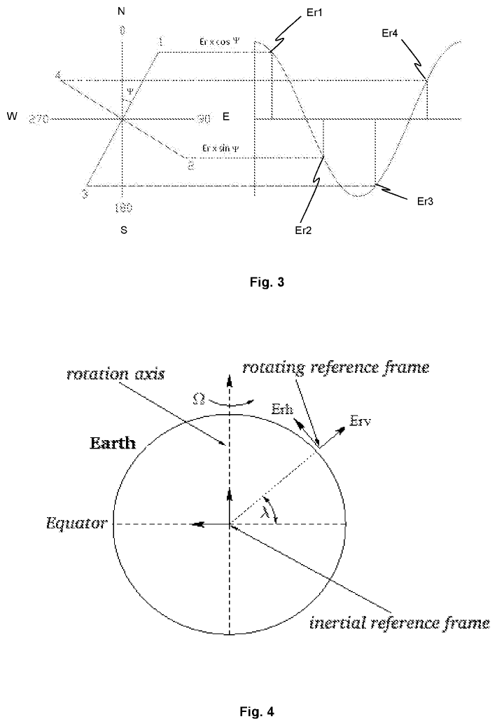

FIG. 3 shows the output of the gyro sensor 1 when rotated about the longitudinal axis 114 of the borehole survey instrument 100. In FIG. 3 it is assumed that the sensing axis 112 of the gyro sensor 106 is horizontal (in other words, parallel to the earth's surface) and that the gyro sensor 106 is rotated about the vertical (i.e. the longitudinal axis of the instrument, with the instrument in the vertical).

As used herein, the term “vertical” encompasses the local vertical; that is, the direction towards the centre of the earth (see the vector Erv in FIG. 4). The term “horizontal” encompasses the local horizontal; that is, a direction perpendicular to the vertical as defined above (see the vector Erh in FIG. 4), or in other words, parallel to the earth's surface. More generally, relative terms such as perpendicular, longitudinal, upper, lower etc. are used herein to aid description and need not be limiting on the scope of the invention.

As described above, the gyro sensor 106 measures the earth's rotation. In particular, when the gyro sensor's sensing axis 112 is aligned horizontally, the gyro sensor 106 measures the horizontal component of the earth's rotation vector (referred to throughout the specification as the horizontal earth rate). Note that although the magnitude of the earth's rotation rate is constant, the horizontal component of the earth's rotation vector depends on latitude. The horizontal rate for a particular latitude, λ, (see FIG. 3), is given by the formula:

Erh=15.041 cos(λ)

FIG. 3 shows that as the gyro sensor 106 is rotated about the longitudinal axis 114 of the borehole survey instrument 100, the output of the gyro sensor 106 describes a sinusoidal waveform. This output is made up of components of horizontal earth rate, Er, as well as a fixed bias drift term, D of the gyro sensor. The combination of the earth rate and the fixed bias drift term may be referred to as the “drift rate” of the rate sensor throughout this specification.

The orientation or azimuth angle with respect to true north is defined as Ψ, with the maximum measured rate being at Ψ=0°, corresponding to when the gyro sensor's sensing axis 112 is aligned to true north.

It is known that measurements of the earth's rotation may be used to determine the alignment of true north by either continuously measuring the gyro sensor 106 output as the sensing axis 112 of the gyro sensor 106 is rotated about the longitudinal axis 114, or by taking measurements at multiple discrete angular orientations as the sensing axis 112 is rotated about the longitudinal axis 114. This is because as the gyro sensor 106 is rotated about the vertical, the horizontal orientation of the gyro sensor sensing axis 112 with respect to true north changes, making it possible to determine the azimuth. This is often referred to as gyrocompassing or northseeking.

An exemplary gyrocompassing technique is described below to illustrate how the azimuth may be determined. In exemplary gyrocompassing techniques, four measurements of the horizontal earth rate components may be taken when the gyro sensor 106 is rotated about the longitudinal axis 114 of the borehole survey instrument 100. The four measurements may be taken at orientations separated by 90 degrees.

The earth's rotation at measurement orientations at 180 degrees apart have equal but opposite values (i.e. Er3=−Er1 and Er4=−Er2), see for example FIG. 3. It will be appreciated that due to the sinusoidal variation in the horizontal earth rate component, measurements taken around the east or west directions (at Ψ=90° and Ψ=270°) provide greater sensitivity because the earth rate component variation with angle change is a maximum whereas it is a minimum around the north and south directions (see FIG. 3).

At each orientation ‘n’ at which a measurement is taken (i.e. at Ψ, Ψ+90°, Ψ+180°, and Ψ+270°). The output of the gyro sensor 106 comprises a drift rate, which as discussed above, includes a fixed bias drift term, D (which may be referred to as a bias), and a horizontal earth rate component, Ern. The gyro output, Ωₙ, at each of the orientations is therefore as follows:

At n=1, Ω₁=Er1+D

At n=2, Ω₂=Er2+D

At n=3, Ω₃=−Er1+D

At n=4, Ω₄=−Er2+D

Although the orientations that are 180 degrees apart (n=Ψ+0°/180° and n=Ψ+) 90°/270° result in a reversal of the measured horizontal earth rate component, Ern, the fixed bias drift term, D, remains substantially constant over the time duration of the earth rate measurements. Consequently, by subtracting gyro sensor outputs that are 180 degrees apart, the fixed bias drift term, D, is eliminated, leaving twice the earth rate, 2·Ern:

Ω₁−Ω₃=(Er1+D)−(−Er1+D)=2·Er1

Ω₂−Ω₄=(Er2+D)−(−Er2+D)=2·Er2

The horizontal earth rate comprises two vectors: a first horizontal earth rate vector and a second horizontal earth rate vector. The two resultant earth rate vectors (derived from the mean value of the two sets of 180 degree points) represent the sine component of the horizontal earth rate (points 2 and 4 in FIG. 3) and the cosine component of the horizontal earth rate (points 1 and 3 in FIG. 3).

These vectors can be used to calculate the azimuth, Ψ, which is the angle of the sensing axis of the gyro sensor with respect to true north, as follows:

$$Ψ = a tan ( \frac{Er 1 - Er 3}{Er 2 - Er 4} ) = a tan ( \frac{Er 1}{Er 2} )$$

Similarly, it can be seen that by adding the measurements that are 180 degrees apart, the horizontal earth rate component, Ern, is eliminated and the fixed bias drift term, D, can be established:

Ω₁+Ω₃=(Er1+D)+(−Er1+D)=2·D

Ω₂+Ω₄=(Er2+D)+(−Er2+D)=2·D

When the inclination of a borehole is within up to 70 degrees of the vertical, the above method can be used to establish the azimuth, to determine the direction of the borehole survey instrument with respect to true north within the borehole.

The borehole survey instrument 100 may also be operable in a continuous mode in which surveying is continuously performed as the borehole survey instrument 100 is transiting down the borehole. Continuous measurement techniques are able to provide data on incremental changes in the azimuth angle of the borehole survey instrument and therefore some means to establish an absolute azimuth angle at a known point in the survey is required. This may conveniently be done by performing a reference gyrocompass step (as described above) when the survey instrument reaches the bottom of the borehole and/or before the survey instrument is dropped into the borehole, to establish an absolute azimuth angle. The reference gyrocompass may however be performed at any convenient time in the overall survey process provided that the survey instrument is stationary and within 70 degrees from vertical, as described previously.

Similarly to gyrocompassing, continuous survey techniques may be optimised dependent upon the inclination of the borehole. The borehole survey instrument may comprise two gyro sensors 106 and 110, wherein one of the gyro sensors is utilised to take continuous survey measurements in a substantially vertical borehole, and the other gyro sensor is utilised to take continuous survey measurements in a substantially horizontal borehole. In the borehole survey instrument 100, the gyro sensor 106 has a sensing axis 112 perpendicular to the longitudinal axis 114 and is utilised for continuous measurements in substantially horizontal boreholes, as described below. The gyro sensor 110 has a sensing axis 117 which is aligned to the longitudinal axis 114 and is utilised for continuous measurements in substantially vertical boreholes, as described below. The gyro sensor 106 may be supported within the sensor module support 104 such that the sensing axis 112 remains in an orientation perpendicular to the longitudinal axis 114 (although the sensing axis 112 may be rotatable about the longitudinal axis). The gyro sensor 110 may be supported within the sensor module support 104 such that the sensing axis 117 is capable of remaining in an orientation in a plane aligned with the longitudinal axis 114; in some arrangements this may mean that the sensing axis 117 is fixed in a plane aligned with the longitudinal axis.

For surveying boreholes at inclination angles around vertical (where vertical is defined as 0° and 90° is horizontal) a ‘roll stabilised’ operating mode may be beneficially employed that utilises the output of the gyro sensor 110 whose sensing axis 117 is aligned with the longitudinal axis 114. In exemplary methods, the borehole survey instrument 100 may operate in the ‘roll stabilised’ operating mode when the borehole is substantially vertical. The borehole may be considered substantially vertical when the inclination of the borehole is ≥0° and ≤45° (however, the borehole survey instrument may continue to operate in the roll stabilised operating mode at inclination angles of >45°).

The borehole survey instrument 100 may operate in the roll stabilised mode when the inclination of the borehole is within a roll stabilised range. The roll stabilised mode range may be ≥0° and ≤45°.

The borehole survey instrument 100 may be configured to operate in the roll stabilised mode when the determined inclination angle is ≥0° and ≤70°. As such, the controller 200 of the borehole survey instrument 100 may be configured to switch the borehole survey instrument 100 into a roll stabilised mode if the data measured by the inclination sensor 108 indicates that the borehole inclination is ≥0° and ≤45° or alternatively ≥0° and ≤70°.

In a “roll stabilised” operating mode, the change in azimuth angle is directly measured by the gyro sensor as the borehole survey instrument travels within the borehole. In the ‘roll stabilised’ operating mode, the gyro sensor 110 may be configured such that the sensing axis 117 of the gyro sensor is initially aligned to the longitudinal axis 114 of the borehole survey instrument 100. As the borehole survey instrument 100 travels through the borehole, the orientation of the borehole survey instrument changes as the azimuth of the borehole changes. The output of the gyro sensor 110 is therefore a measurement of the rate of rotation of the borehole survey instrument, and as such the rate of rotation of the sensor module support 104 supporting the gyro sensor 110. The output of the gyro sensor 110 is fed back to the controller 200, which controls the rotation drive mechanism to rotate the sensor module system 103, about the axis 114, such that the angular rate of the sensor module system 103 is “nulled” as the azimuth angle of the borehole rotates. In other words, the rotation mechanism drives the sensor module system 103 such that it rotates as the azimuth of the borehole rotates in order to cancel the rate measured by the gyro sensor 110.

The gyro sensor 110 will however, only measure a component of the azimuth angle rotation of the borehole survey instrument 100 with the magnitude varying as the cosine of the inclination angle, Θ, of the borehole. The inclination sensor 108 may therefore comprise an accelerometer, which may be a three-axis accelerometer. For a constant inclination angle, the X and Y axis accelerometer outputs, GX and GY, would vary sinusoidally as the azimuth angle rotates (where X and Y lie in a plane perpendicular to the longitudinal axis 114). These outputs may be used to derive the high side angle, α, which is defined as the angular direction of the upward vertical in the XY plane of the survey instrument (where the Z direction is the longitudinal axis of the survey instrument). The angle α is defined by the equation:

$$a = a tan ( \frac{{G}_{X}}{{G}_{Y}} )$$

The incremental changes in high side angle, Δα, may be used to derive changes in the azimuth angle, ΔΨ, where:

$$ΔΨ = \frac{Δα}{sin Θ}$$

The initial azimuth angle, Ψ0, may be measured using a gyrocompass survey before the borehole survey instrument enters the borehole, as previously described the azimuth angle, ΨN, is given by:

$${Ψ}_{N} = {Ψ}_{N - 1} + ΔΨ = {Ψ}_{N - 1} + \frac{Δα}{sin Θ}$$

If the absolute azimuth angle is measured at the end of the in run survey then preceding azimuth values are calculated by subtracting the incremental changes:

Ψ_{N-1}=Ψ_{N}−ΔΨ

For borehole inclination angles that are relatively close to horizontal the borehole survey instrument may be operated in a ‘gravity stabilised’ mode that utilises the output of the gyro sensor 106 whose sensing axis 112 is perpendicular to the longitudinal axis 114 of the borehole survey instrument 100. This mode may also be referred to as a ‘high side’ mode where the high side angle α is as defined previously (the high side angle may also be referred to as a gravity roll angle from vertical). The borehole survey instrument may operate in the gravity stabilised mode when the borehole is substantially horizontal. The borehole may be considered substantially horizontal when the inclination of the borehole is >45° (where vertically downwards is defined as 0° and horizontal as 90°). However, the borehole survey instrument may continue operate in the gravity stabilised mode at inclination angles of <45°. The controller 200 of the borehole survey instrument 100 may be configured to switch the borehole survey instrument 100 into a gravity stabilised mode when the borehole is substantially horizontal.

The borehole survey instrument may operate in the gravity stabilised mode when the inclination of the borehole is within a gravity stabilised mode range. The controller 200 of the borehole survey instrument 100 may be configured to switch the borehole survey instrument 100 into a roll stabilised mode if the data measured by the inclination sensor 108 indicates that the borehole inclination is within the gravity stabilised mode range.

The gravity stabilised mode range may be >45° (where vertically downwards is defined as 0° and horizontal as 90°). The borehole survey instrument 100 may be configured to operate in the gravity stabilised mode when the determined inclination angle is >20°. In the gravity stabilised mode, the output from the inclination sensor 108 in the sensor module support 104 is used to maintain the sensor module system 103 orientation in the XY plane at a constant angle (where Z is along the longitudinal axis of the borehole instrument). That is, the orientation of the sensor module support 104 within the borehole survey instrument 100 needs to be such that at all points during the survey, the gyro sensor sensing axis 112 is maintained in a direction as close to vertical as possible within the XY plane (if the borehole survey instrument is in a horizontal borehole, the sensing axis 112 would be maintained in a vertical direction in the XY plane). During the survey, as the borehole survey instrument 100 moves through the borehole, the borehole survey instrument itself may rotate, altering the direction of the rate sensor sensing axis 112 within the XY plane, away from the direction that is as close to vertical as possible (e.g. away from vertical). The data collected by the inclination sensor 108 can be used to feedback, to the controller 200, information on the rotation of the borehole survey instrument, 100 and the rotation drive means 116 may be actuated by the controller 200 to rotate the sensor module support 104 about the longitudinal axis 114 of the borehole survey instrument 100 to maintain the gyro sensor sensing axis 112 in the direction as close to vertical as possible within the XY plane. As a result, the inclination sensor 108 with its sensing axis aligned orthogonally to both the gyro sensor sensing axis 112 and longitudinal axis 114 is zero i.e. it is aligned horizontally.

For a perfectly horizontal borehole the gyro sensor sensing axis 112 would therefore be aligned vertically and would directly measure any rotation, ΩH, in the borehole angular direction in the horizontal earth plane. The rate output from the gyro sensor 106 may then be integrated to provide a measurement of the incremental angle change of the borehole in the horizontal plane.

Any deviation in the inclination angle, Θ, of the wellbore from horizontal will decrease the measurement sensitivity of the gyro sensor, as the gyro sensor will only sense a component, ΩR, of the rotation rate ΩH, given by:

Ω_{R}=Ω_{H} cos Θ

This mode therefore works optimally for angles close to horizontal and is not applicable at angles close to vertical. For example, the gravity stabilised mode may be used at angles within ±70° of horizontal, or even at angles within ±80° of horizontal in some instances. The inclination angle, Θ, may be derived using the accelerometer outputs GX, GY and GZ as follows:

$$Θ = a tan ( \frac{{G}_{R}}{{G}_{Z}} )$$

$$Where , \\ {G}_{R} = \sqrt{{G}_{X}^{2} + {G}_{Y}^{2}}$$

This enables the value of ΩH, and hence the angle increment, to be derived.

For accurate operation in either a roll stabilised or gravity stabilised continuous mode, the gyro sensors 106 and 110 may be calibrated to remove the bias error of the gyro sensors 106 and 110 and to prevent the accumulation of angle errors over time. As discussed above, the calibration may be performed as a gyrocompassing step either before the survey begins, or once the borehole survey instrument reaches the bottom of the borehole. The bias of the gyro sensors 106 and 110 may be determined by measuring the output of the gyro sensor when the borehole survey instrument 100 is stationary, before the borehole survey instrument 100 is dropped into the borehole. However, even after this initial calibration the bias value can vary over the course of the in run survey, as the borehole survey instrument falls within the borehole. The effect of the bias changes may be mitigated by obtaining an updated bias value once the borehole survey instrument has reached the bottom of the borehole and is known to be stationary. If significant changes in the azimuth or inclination angle occur between the two bias measurements, then it may be beneficial to apply a compensation to remove the change in the earth rate contribution to the stationary gyro output. This may be done using the calculated values of azimuth and inclination obtained during the survey, if required. Any change in the bias between the start and end points may assumed to be linear, as is known in the art, and may be corrected for during subsequent processing of the survey data. The combination of the gyro sensor bias and earth rate contribution may be referred to as the drift rate error. This may be measured directly by observing the gyro output when the survey instrument is stationary.

The change in bias for the gyro sensors and inclination sensors, such as accelerometers, may be significantly influenced by changes in temperature over the duration of the survey due to variations in the local temperature at different depths along the wellbore. High rates of change of temperature may be experienced during the out run survey, which is typically of longer duration that the in run survey (in which the borehole survey instrument is in freefall). In an alternative embodiment, the borehole survey instruments 100 may additionally comprise a heat shield. The borehole survey instrument 100 may be housed within the heat shield. The heat shield is configured to elongate the time taken for the gyro sensors and inclination sensors to reach the ambient temperature external to the borehole survey instrument. The heat shield therefore increases a time constant for the transfer of heat between the external environment and the sensors housed inside. Due to the rapid transit time of the borehole survey instrument to the bottom of the borehole when used in a drop survey, the internal temperature rise is limited during the in run of the borehole survey instrument, since the borehole survey instrument typically is not in exposed to the local environment for long enough for substantial heat transfer. Temperature related changes in bias on the in run are therefore significantly reduced when using a drop instrument, compared to wireline or slickline operation.

The rapid transit of the borehole survey instrument during the drop is additionally advantageous in limiting the accumulation of errors due to the bias drift. However, the speed through the hole can be high (up to ^{˜}5 m/s) if uncontrolled in substantially vertical boreholes and therefore the shock experienced on impact at the bottom of the borehole can be very high.

Various techniques are known to limit the transit speed of the survey instrument during the drop and to reduce the shock experienced by the sensors during impact at the bottom of the well. For example, U.S. Pat. No. 6,209,391 describes the use of buoyancy aids or traverse disks which induce turbulence, to control the rate of descent of a survey instrument. The survey instrument may however still be subjected to high levels of shock (>1000 g). Suitable rate sensors for drop survey instruments are therefore capable of surviving and operating without significant performance degradation after such shocks. The performance capability should also be consistent with the accuracy requirements for accurate surveying.

As such, the gyro sensors 106 and 110 of the borehole survey instrument 100 may comprise Micro-Electro-Mechanical-Systems (MEMS) gyro sensors and the inclination sensor 108 may comprise a MEMS accelerometer. MEMS sensors may be configured to survive and operate without performance degradation after impact at the bottom of the borehole and are also sufficiently compact to fit within borehole survey instruments. The MEMS gyro sensors 106 and 110 may have a bias stability level of less than 1 degree per hour. A bias stability level of less than 1 degree per hour allows the same gyro sensor to be utilised during the in run survey and the out run survey but also for performing gyrocompass measurements to obtain an absolute azimuth angle. The stability level of less than 1 degree per hour also advantageously allows continuous measurements of in run data, indicative of azimuth and inclination of the borehole, to be taken to an acceptable degree of accuracy over the short duration of a typical drop survey. A suitable exemplary MEMS gyro sensor is the Tronics GYPRO3300.

Using a gyro sensor with a bias stability level of less than 1 degree per hour also eliminates the need to combine a continuous in run survey with high accuracy, gyrocompassing out run survey data to correct the errors in the absolute azimuth angles arising due to the gyro sensor bias drift. A correction method utilising gyrocompassing methods during the out run survey is described in US20170175517 (which uses gyro sensors with a bias stability level of 5-10 degrees/hour). The data for correcting the errors in the absolute azimuth angle can only be obtained using more expensive, higher accuracy gyro sensors. These must either be additionally incorporated within the borehole survey instrument or alternatively, this data may be obtained in a separate survey using a different survey instrument incorporating higher accuracy gyro sensors.

In known systems gyrocompassing techniques are used in order to obtain azimuth data during the out run of a borehole survey instrument. Gyrocompassing is typically performed when the borehole survey instrument is stationary between drill rod pulls (i.e the removal of individual sections of pipe that form part of the drill string) as the drill string is removed. Gyrocompassing requires the borehole survey instrument to be stationary and as such the time between drill rod pulls of the drill string provides a convenient point at which to gyrocompass.

However, even utilising the most accurate MEMS gyro sensors, typically the total stationary time required for gyrocompassing is in the range of one to two minutes. This is longer that the time that would usually be taken between rod pulls during recovery of the drill string and therefore elongates the overall operational time for removing the drill string. The inventors have realised that advantageously, continuous measurement techniques may be used during the out run, as the borehole survey instrument is removed from the borehole. This eliminates the requirement to elongate the stationary period between rod pulls (as is necessary when gyrocompassing) and thus provides a significant operational efficiency improvement.

As such, the borehole survey instrument 100 may be configured to operate in the continuous mode during the out run and as the borehole survey instrument 100 is removed from the borehole. The gyro sensors 106 or 110 and inclination sensor 108 may continuously measure out run data indicative of azimuth and inclination of the borehole as the borehole survey instrument 100 is removed from the borehole.

The overall time taken to recover a drill string, along with the borehole survey instrument, is significantly longer than the comparatively short time taken for the drop survey. For example, for a borehole of around 4000 m in depth, recovery of the borehole survey instrument by removing the drill string may take up to 12 hours, whereas the in run of a drop borehole survey tool may typically only take around 20 minutes. The total bias drift during the time taken for the out run survey therefore may be significantly greater than that during the in run, due to the longer overall elapsed time and the consequently greater changes in temperature of the gyro sensor 106 or 110 and inclination sensor 108.

Since the drill string and borehole survey instrument 100 are stationary between rod pulls, the drift rate of the gyro sensors 106 and 110 can be measured at frequent intervals and its effect on the azimuth accuracy corrected. The drift rate is a measurement of the bias and the earth rate at the point of measurement and can be used as an estimate of bias of the gyro sensors 106 and 110. The drift rate may be measured for gyro sensors 106 and 110 without performing a gyrocompassing step and as such without elongating the time between drill pipe removal. A measurement of the drift rate can be derived by simply measuring the gyro sensor output while the borehole survey instrument 100 is stationary. This is because when the borehole survey instrument is in a continuous mode, the rate of change of azimuth is measured directly. As such, in the continuous modes, the output of the gyro sensor during drill pulls comprises the rate of change of azimuth, the bias and the earth rate component. During the stationary periods, because the gyro sensor is in a fixed orientation, the output of the gyro sensor will comprise only the drift rate (i.e. the bias and the earth rate component). The drift rate measured during the stationary period can therefore be subtracted from measurements taken during continuous mode operation (e.g. during a subsequent rod pull) in order to correct the rate of change of azimuth measurements. Alternatively, the drift rate may be subtracted from a rod pull conducted previously measurement of the drift rate. Over the typical <1 minute duration of the individual continuous out run survey steps (i.e. the duration of the rod pulls) the effect of drift rate may therefore be estimated using the above method during each stationary period during the out run. Alternatively, the drift rate may be measured less frequently and at intervals, for example every tenth stationary period, as the bias change will only have a limited effect on the overall survey accuracy over this elapsed time.

As discussed above, a gyrocompassing step may take approximately 1 to 2 minutes to perform. In comparison, the drift rate may be measured for a duration of time between rod pulls. For example, the drift rate may be measured for a period of less than 60 seconds (or alternatively in a period of less than 50 seconds or less than 40 seconds or less than 30 seconds). As such, operational efficiency is improved.

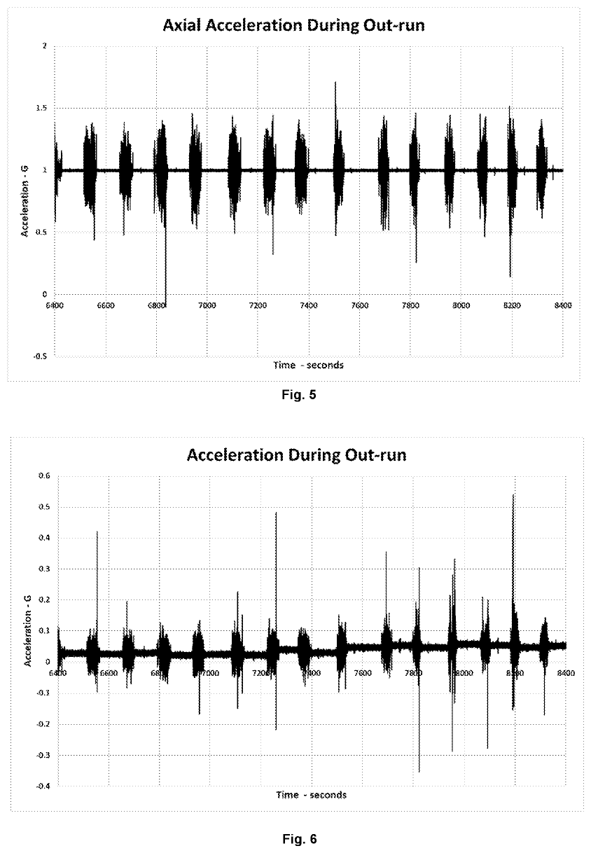

The borehole survey instrument 100 may be further configured to identify when the borehole survey instrument is stationary and as such when the drift rate of the gyro sensors 106 and 110 may be measured. This can be done using known techniques to monitor the accelerometer and gyro data which will alternate between relatively noise free output (that is, a stable output) between rod pulls to more random, noisy output when the rods are in motion. FIG. 5 shows the output of the accelerometer 108 along an accelerometer sensing axis parallel to the longitudinal axis 114 of the borehole survey instrument 100 for a sample range during a rod pull. The output of the accelerometer is relatively noisy during the rod pulls which are of ^{˜}40 second duration, with typical deviations in a range of ±0.25G. Distinct periods of stable output of 1 to 2 minutes are observed between rod pulls. Similar perturbations are outputted along the accelerometer sensing axes perpendicular to the longitudinal axis 114 of the borehole survey instrument 100 (i.e. along one of the two the radial axes) as shown in FIG. 6. The application of a noise or acceleration change threshold detection method to distinguish between these states will enable the stationary periods to be identified. This data may be feedback to the controller 200, which may determine when the drift rate can be measured. For example, the borehole survey instrument may be configured to determine that the instrument is stationary if no change in output of greater than ±0.1G is observed in the longitudinal accelerometer output over a period of 5 seconds. In some arrangements, a combination of the measurements taken along the accelerometer sensing axis parallel to the longitudinal axis 114 and the measurements taken along the accelerometer sensing axis perpendicular to the longitudinal axis 114 may be utilised to increase the accuracy and reliability in identifying stationary periods.

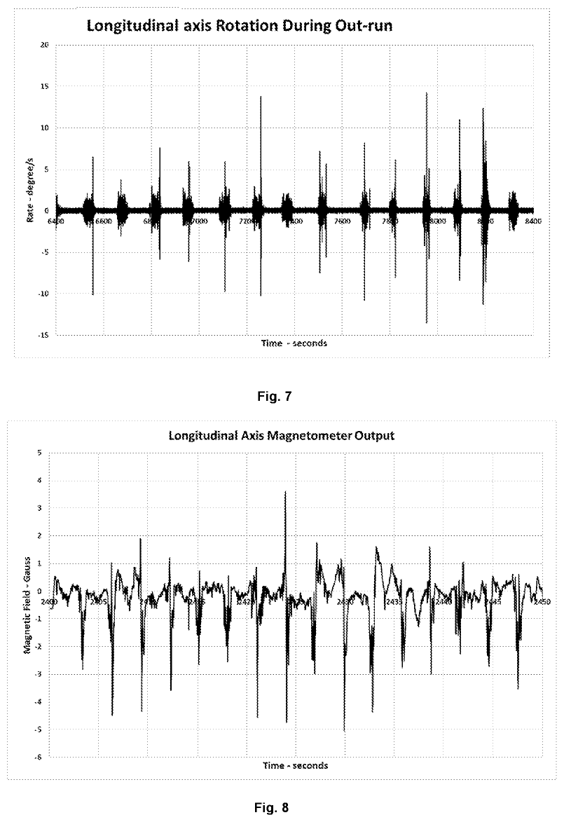

In addition to the linear accelerations applied during the rod pulls, there may be a rotation of the drill string around the axis of the borehole. FIG. 7 shows the measured rotation rate of the gyro sensor 110 about the longitudinal axis 114 during the same rod pulls as shown in FIGS. 5 and 6. Again noisy periods with typical rates of ±1 deg/s and higher transient peak rates are measured during the rods pulls with stable output during the stationary periods.

It will be understood that the roll stabilised continuous survey mode, during either the in run or the out run, will rotate the sensor module 104 in order to cancel any applied rotation as described above, thus maintaining a constant angular orientation around this axis. The rotation of the sensor module 104 with respect to the survey instrument housing 102 can therefore be measured, for example using an encoder. An encoder angle noise or angular acceleration threshold detection method may similarly be applied to differentiate between the stationary periods and the rod pulls.

A method for conducting a continuous borehole survey during an out run is described below, with reference to FIG. 1.

Optionally, an initial gyrocompass step may be performed as described above before the borehole survey instrument 100 is dropped into the borehole in order to determine an absolute azimuth angle.

The borehole survey instrument 100 is dropped into a borehole and freefalls within the borehole until impact with a bottom of the borehole. Sensors of the borehole survey instrument 100 (which may be magnetometers, accelerometers or gyro sensors) detect when the survey instrument comes to rest at the bottom of the borehole. This is described in more detail below.

Optionally, a gyrocompass step may be performed as described above in order to determine a reference absolute azimuth angle, while the borehole instrument is stationary at the bottom of the borehole. This may be performed in addition to or as an alternative to the gyrocompass step optionally performed at the start of the in run survey. The borehole survey instrument 100 may therefore initially be in a gyrocompass mode. It will be understood that in some methods only one of the gyro sensors 106 and 110 may perform the gyrocompassing step, since only one gyrocompass step is necessary to establish an absolute value for azimuth to use as a reference (and only one gyro sensor sensing axis will be aligned with the horizontal). For example, the gyro sensor 106 may perform the gyrocompass step.

Once the reference azimuth angle is determined, the borehole survey instrument 100 may switch into a continuous mode. For example, the borehole survey instrument 100 may switch into a roll stabilised continuous mode, under the control of the controller 200 such that the gyro sensor 110 continuously measures data. In the continuous mode, the rate sensor 106 or 110 and the inclination sensor 108 are configured to continuously measure in run data indicative of azimuth and inclination of the borehole. The out run data may be stored in the memory 2b of the controller 200. The rate sensor and inclination sensor therefore continuously measure out run data as the drill string is removed from the borehole

The removal of the borehole survey instrument may be repeatedly paused as the drill string is removed from the borehole. A first drill rod of the drill string is removed from the borehole and the rate sensor 106 or 110 and the inclination sensor 108 continuously measure the out run data during the first drill rod pull. The removal of the borehole survey instrument is then paused before the second drill rod of the drill string is removed. As described above, the output of the gyro sensor and/or the accelerometer may be utilised to determine when the borehole survey instrument is stationary between drill pulls using the output of the accelerometer 108 and/or gyro sensor 106 or 110 (depending on whether the borehole survey instrument is in roll stabilised or gravity stabilised continuous mode).

The output of the accelerometer 108 and/or gyro sensors 106 and 110 may be fed back to the controller 200. The controller may be configured to use the output of the accelerometer 108 and/or gyro sensors 106 and 110 in order to determine whether the borehole survey instrument is stationary.

If the borehole survey instrument is determined to be stationary, the drift rate of the gyro sensor is measured as described above, without gyrocompassing. In other words, the controller may be configured to use the output of the gyro sensors 106 and 110 as a measurement of drift rate of the respective gyro sensors 106 and 110 if the borehole survey instrument is determined to be stationary. As such, the borehole survey instrument remains in the continuous mode (that is, there is no switching of the borehole survey instrument into the gyrocompass mode during the out run). The measured drift rate, which is the output of the gyro sensor 106 or 110 when the borehole survey instrument is stationary, and which comprises the bias and an earth rate component, may be utilised to correct the azimuth data collected during the next drill rod pull. Alternatively drift rates determined at each stationary point may be used to correct the azimuth data, for example by assuming a linear variation of drift rate with time between stationary points.

The second drill rod is then removed from the borehole and the above process is repeated until the drill string and borehole survey instrument 100 are both extracted.

It will be understood that as the borehole survey instrument descends within or is extracted from the borehole, the data indicative of inclination may be fed back to the controller 200. If the inclination data indicates that the borehole inclination is within a gravity stabilised mode range, indicating that a section of the borehole is close to horizontal, the controller may control the borehole survey instrument 100 to switch into a gravity stabilised continuous mode. As such, the gyro sensor 106 would continuously measure in run data for the section of the borehole determined to be close to horizontal. The borehole survey instrument may switch between the roll stabilised continuous mode (in which the gyro sensor 110 collects data) and gravity stabilised continuous mode (in which the gyro sensor 106 collects data) under control of the controller 200 in response to the borehole inclination determined by the inclination sensor 108. The borehole survey instrument may switch between the roll stabilised and gravity stabilised modes multiple times during the in run survey and the out run survey.

In order to obtain a complete set of borehole survey data, a determination of depth of the borehole at any point during the survey to a high degree of accuracy may be obtained. As such, depth data may be collected which is indicative of the depth of the borehole at the point at which the depth data is collected. Out run depth can easily be determined during the out run as the drill rods are of known length. Depth can therefore be established and correlated to azimuth and inclination data collected by the borehole survey instrument 100 as the drill rods are removed.

However, in the absence of a wireline or slickline, alternative techniques may be employed to measure the depth along the borehole during the in run, when the borehole survey instrument is in freefall.

In one embodiment, the borehole survey instrument 100 further comprises at least one magnetic sensor, which is responsive to changes in the ambient magnetic fields induced by casing collars and pipe joints between drill rods within the borehole which are at a known separation (typically of ^{˜}10 m). As such, the magnetic sensor is configured to measure magnetic data. The geometry of the pipe sections of the drill string in these areas differs from the uniform pipe profile between the joints and the magnetic field intensity and direction is generally distorted at the joints. These distortions are readily detectable using commercial, low cost, three-axis magnetometers of the type commonly used in consumer products such as mobile phones or gaming applications. Suitable exemplary devices which incorporate such magnetometers include the InvenSense MPU9250 or Kionix KMX62-1031.

FIG. 8 shows the output of an axis of the three axis magnetometer device aligned with the longitudinal axis 114 of the borehole survey instrument 100, as the borehole survey instrument 100 freefalls within a borehole. Transient shifts of between 2 and 5 Gauss are clearly visible as the magnetometer passes the pipe joint areas.

FIG. 9 shows the output of one of the radial axes (i.e the axes aligned perpendicular to the longitudinal axis 114 of the borehole survey instrument 100) of the 3 axis magnetometer over the same time period. Similar features, but of a reduced amplitude, are visible at the same points as those on the longitudinal magnetometer axis. These features can be tracked for example, by applying a threshold detection technique which identifies abrupt changes in signal level over short periods of time. For example, points at which the change in magnetic data measured is greater than a magnetic threshold within a given threshold time period, may be determined to be indicative of a pipe joint. The magnetic threshold level shift (that is, the magnetic threshold, which is the rate of change of magnetic data measured by the magnetometer) may be substantially a change in output of >±1.5 Gauss and the threshold time period may be ^{˜}1 second for the longitudinal magnetometer output shown in FIG. 8. The threshold time and level may however be adjusted depending on the transit speed of the instrument along the wellbore and the observed magnitude of the magnetic disturbances for any given wellbore. As such, an indication is provided of the time at which the survey instrument passes the pipe joints, which are of a known spacing due to the uniform lengths of pipe used in the drill string. The depth can of the borehole can therefore be calculated and the inclination and azimuth angle data at these points in time in the survey can then be correlated with an accurate depth measurement. In some arrangements, a combination of the measurements taken along the magnetometer sensing axis parallel to the longitudinal axis 114 and the measurements taken along the magnetometer sensing axis perpendicular to the longitudinal axis 114 may be utilised to increase accuracy and reliability in identification of the transit past pipe joints.

When the borehole survey instrument 100 is in freefall, the speed will initially increase in a predictable manner under the influence of gravity before reaching a uniform terminal velocity. The speed between successive joint transients is therefore highly predictable and the depth at all times between transients may therefore be estimated to a high degree of accuracy. The terminal velocity may therefore be utilised to compensate for noise in the output of the magnetometer, since once the instrument reaches terminal velocity, it should pass successive pipe joints in regular intervals.

In another embodiment, accelerometers may also be used to collect depth data by identifying the pipe joints by continuously collecting accelerometer data during the in run. A magnetometer may be used in combination with an accelerometer to detect the pipe joints. As such, in one embodiment, the borehole survey instrument 100 comprises a module system comprising an accelerometer (e.g. a 3 axis accelerometer) and a magnetometer (e.g. a three axis magnetometer).

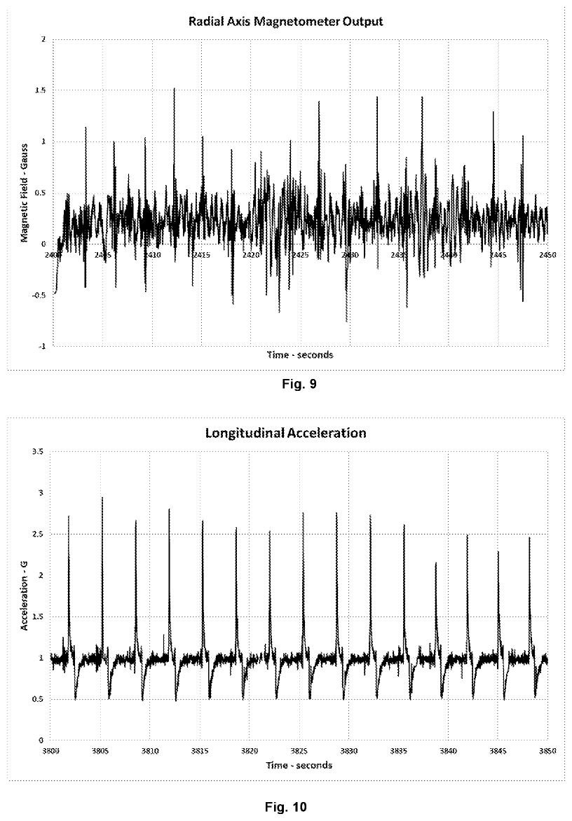

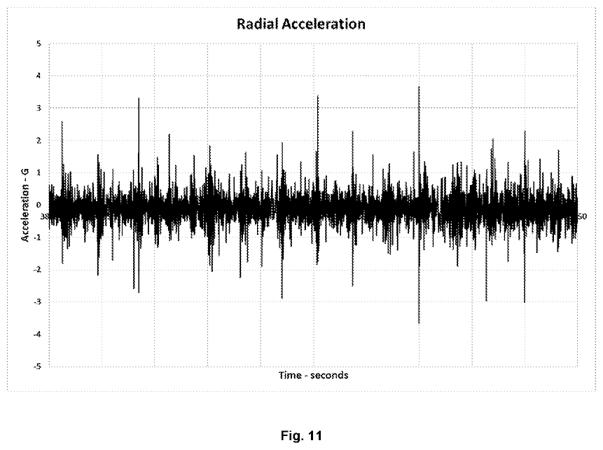

As the borehole survey instrument passes the pipe joints, discontinuities in the surface profile of the inner pipe diameter will induce transient linear displacements. These perturbations may be detected by the three axis accelerometers within the module system. FIGS. 10 and 11 show respectively exemplary data for the longitudinal and one of the radial axes of the three axis accelerometer mounted within the module system, respectively. Clear perturbations are visible as the borehole survey instrument passes the pipe joints. This data was recorded from a drop survey where the survey instrument is travelling at ^{˜}3 m/s through the borehole. Peak deviations of between 2 g and 3 g are observed in the longitudinal axis (see FIG. 10) with similar deviations, although less distinct, in the radial direction (see FIG. 11). Again, transient signals are visible which may be identified using similar threshold detection techniques as those applied for magnetic perturbations. An accelerometer threshold level shift (that is, the acceleration threshold, which is the rate of change of accelerometer data measured by the inclination sensor) may be substantially a change in output of ±1.5 g and a threshold time period may be substantially ^{˜}1 second for the longitudinal accelerometer output shown in FIG. 10. The threshold time and level may however be adjusted depending on the transit speed of the instrument along the wellbore and the observed magnitude of the acceleration disturbances for any given wellbore. The accelerometer data may be used alternatively or in combination with the magnetometer data. Using a combination of one or more of the accelerometer and magnetometer data may be beneficial in avoiding the possibility of spurious signals giving rise to invalid indications of pipe joints or to aid post-processing in the event that spurious signals are generated.

Alternative depth measurement techniques may also be employed. The data from an accelerometer with its sensing axis aligned along the z-axis (i.e. along the length of the borehole) may be double integrated to derive distance travelled along the borehole. This requires the use of a relatively high performance accelerometer in order to obtain measurements of sufficient accuracy. The MEMS accelerometers provided in packages with accompanying magnetometers typically have bias and scale factor instabilities which are too high to enable sufficiently accurate measurements to be made. Alternative technologies such as servo balanced quartz accelerometers, while being larger and more expensive, are capable of achieving the required performance levels and may be fitted within the survey instrument. An example of a suitable accelerometer device is the JA-25GA supplied by JAE Ltd.

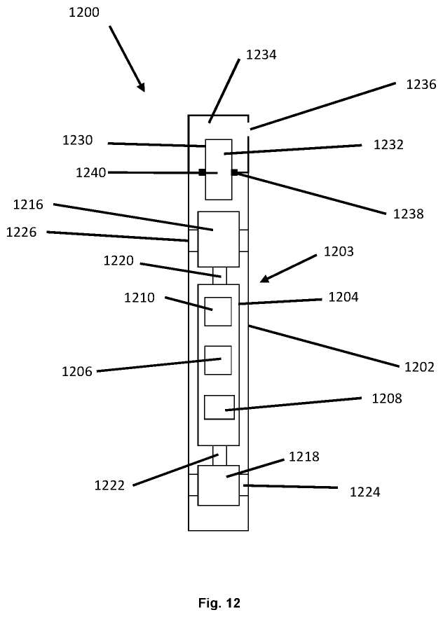

An alternative depth measurement technique makes use of measurements of the fluid pressure within the borehole. In a further embodiment, a borehole survey instrument 1200 as shown in FIG. 12 may be utilised. The borehole survey instrument 1200 may comprise the features of the borehole survey instrument 100 of FIG. 1. Similar reference numerals are therefore used to denote the same features as in FIG. 1, except using a “12”. The borehole survey instrument 1200 may additionally comprise a fluid pressure sensor 1230. The borehole survey instrument housing 1202 may further comprise a compartment 1234 which houses a portion of the pressure sensor 1230. In the embodiment of FIG. 12, a sensing portion 1232 of the pressure sensor 1230 is housed within the compartment 1234. The compartment comprises a pressure inlet 1236 in a wall of the compartment 1234, such that the pressure sensor 1230 may be directly exposed to the fluid within the borehole via the pressure inlet 1236.

The compartment 1234 isolates the sensing portion 1232 of the pressure sensor 1230 from the rest of the components housed within the borehole survey instrument housing 1202. This may be achieved via an aperture 1240 in a wall of the compartment 1234, wherein the aperture 1240 is configured to receive the pressure sensor 1230. The pressure sensor 1230 is mounted within the aperture such that the electronic components and contacts (to provide power and pressure data output) are isolated from the compartment (which is exposed to the fluid within the borehole via the pressure inlet 1236). In the borehole survey instrument 1200, a seal 1238 isolates the sensing portion 1232 of the pressure sensor 1230 housed within the compartment 1234 from the rest of the components within the borehole survey instrument housing 1202. The seal 1238 may be configured to prevent water ingress through the aperture 1240 into the portion of the borehole survey instrument housing 1202 in which electronic components are enclosed.

The borehole survey instrument 1200 may be utilised to provide depth measurements as described below.

The fluid pressure within the borehole can be assumed to vary approximately linearly with depth, however variations in the density or temperature of the fluid within the borehole may induce small variations in this behaviour. Determining depth utilising absolute pressure measurements could therefore be used to calculate vertical depth but would require accurate knowledge of the fluid characteristics, including temperature and density, and also any variation in these parameters along the length of the borehole. This would necessitate the use of a highly accurate pressure measurement sensor in order to obtain accurate depth measurements.

The present technique makes use of the fact that the measured pressure variation will vary in a known, repeatable manner along the length of the borehole.

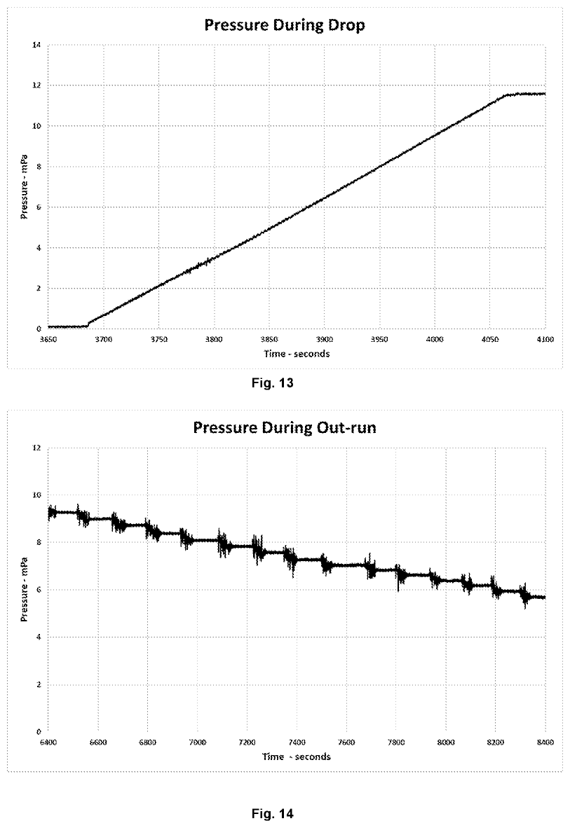

During the in run, as the borehole survey instrument 1200 freefalls within the borehole, measurements of pressure are taken continuously by the pressure sensor. The pressure variation as a function of the distance along the borehole is therefore recorded.

Where the borehole is vertical the pressure change versus distance will be a maximum but will reduce as the borehole deviates into the horizontal plane. The rate of pressure variation along the borehole may therefore change significantly depending on the inclination angle of the borehole. FIG. 13 shows the results obtained for a drop in run of an exemplary borehole of ^{˜}1200 m depth which is substantially vertical. The pressure changes broadly linearly once the borehole survey instrument 1200 has reached a constant terminal velocity as it falls within the wellbore.

The pressure sensor 1230 also continuously measures pressure during the out run, as the borehole survey instrument 1200 is removed from the borehole. As described above, the borehole survey instrument 1200 is removed drill rod sections of the drill string, which are of known length (typically ^{˜}10 m). FIG. 14 shows the out run pressure data recorded for a portion of the drill string recovery for the same borehole as FIG. 13. Some short term variation in pressure is observed during the drill rod pulling stage as the drill string is in motion with stable pressures observed while the drill string is stationary and at a constant depth. The depth at these points is known from the number and length of the drill rod sections. As such, the pressure at the points of known depth can be correlated with the points of equal pressure measured during the in run and out run surveys, indicating equivalent depths associated with the in run survey data.

This process provides an accurate correlation of the pressure versus displacement along the borehole for these points.

Any errors in the pressure sensor output, such as scale factor non-linearity or temperature variation of the bias or scale factor, will therefore not unduly degrade the accuracy of the technique provided that they are repeatable and do not change substantially between the in run and out run measurements. The pressure measurements recorded during the in run survey may therefore be accurately converted to distance along the borehole using the out run pressure information.

The accuracy of the borehole displacement measurement using this technique is therefore not dependent upon the absolute accuracy of the pressure sensor. The accuracy will be determined by the repeatability and stability of the sensor over the total survey measurement duration time enabling a lower grade, less expensive sensor to be utilised.

The outputs of the magnetometer, accelerometer, gyroscope and pressure sensors may also be conveniently used in order to detect when the survey instrument comes to rest at the bottom of the wellbore. At this point the periodic transient magnetometer and accelerometer signals, seen in FIGS. 8, 9, 10 and 11, which occur as the instrument passes the pipe joints, will cease. If no such signals are detected after a pre-defined time, which may be relatively short (e.g. >10 s) then the survey instrument can be assumed to be stationary. Similarly, the pressure sensor output, which varies as shown in FIG. 13 during the in run drop, may be monitored to identify when the survey instrument has become stationary at the bottom of the wellbore. The pressure varies by ^{˜}0.03 mPa per second in FIG. 13 before reaching a fixed value when stationary. In this instance, if the pressure is stable to within 0.1 mPa over a 10 s period the survey instrument may be assumed to be stationary and to have reached the bottom of the wellbore. The pressure sensor, magnetometer, accelerometer and gyroscope output may be used in isolation or a combination of outputs used to identify when the survey instrument has become stationary at the bottom of the wellbore. At this point it may be advantageous to switch the instrument into gyrocompass mode which enables an absolute azimuth angle to be measured. This is useful as it provides a reference against which the azimuth angle calculated from the continuous survey data can be checked. Any deviation can be assumed to arise due to errors in the gyro bias value during the in run drop and corrections may be applied accordingly to improve the overall in run survey accuracy. This gyrocompass can also provide a reference starting azimuth point for the continuous out run survey.

The bottom hole gyrocompass survey may also be initiated based on elapsed time. The survey instrument can alternatively be programmed to switch into this mode of operation after a pre-defined elapsed time which is sufficient to ensure that it has come to rest at the bottom of the wellbore. This time may be calculated based on the known total depth and the viscosity of the drilling fluid. The total well depth will be known from the number of drill pipe sections of known length which have been deployed from the start of the drilling operation.

The skilled person will understand that references to “continuous” surveys does not necessarily mean that that the borehole survey instrument is continuously moving. As described above, during an out run typically the borehole survey instrument will be stationary at regular intervals between rod pulls. As such, the term “continuous” should be understood to encompass a measurement technique which does not require gyrocompassing to take place during the measurement. Continuous measurements therefore measure incremental changes, relative to a previous measurement or value, in contrast to gyrocompassing, which measures absolute values. As discussed elsewhere, gyrocompassing may take place before the continuous measurement and/or after the continuous measurement.

1. A method for collecting borehole survey data indicative of geometry of a borehole, using a borehole survey instrument comprising at least one rate sensor and an inclination sensor, the method comprising:
dropping the borehole survey instrument into the borehole, such that the borehole survey instrument freefalls to a bottom of the borehole; and
continuously measuring out run data indicative of azimuth and inclination of the borehole, using the at least one rate sensor, and the inclination sensor, as the borehole survey instrument is removed from the borehole.

2. A method according to claim 1, further comprising:
repeatedly pausing removal of the borehole survey instrument; and
measuring, using an output of the at least one rate sensor, a drift rate of the at least one rate sensor when the borehole survey instrument is stationary.

3. A method according to claim 2, further comprising correcting the data indicative of azimuth measured by the rate sensor using the measured drift rate.

4. A method according to claim 2, further comprising:
determining whether the borehole survey instrument is stationary using the at least one rate sensor and the inclination sensor.

5. A method according to claim 4, wherein a stable output from at least one of the at least one rate sensor and the inclination sensor indicates that the borehole survey instrument is stationary.

6. A method according to claim 2, wherein the drift rate of the at least one rate sensor is measured without gyrocompassing.

7. A method according to claim 6, wherein the drift rate of the at least one rate sensor is measured for a period of 30 seconds or less.

8. A method according to claim 1, further comprising:
continuously measuring in run data indicative of azimuth and inclination of the borehole, using the at least one rate sensor and the inclination sensor, as the borehole survey instrument freefalls to the bottom of the borehole.

9. A method according to claim 8, further comprising:
validating one of the in run data and the out run data using the other of the in run data and the out run data to provide a validated borehole survey, or
using the in run data and the out run data to produce two continuous borehole surveys, each providing the azimuth and the inclination of the borehole.

10. A method according to claim 8, wherein the method further comprises:
continuously recording accelerometer data using the inclination sensor, as the borehole survey instrument freefalls to the bottom of the borehole;
detecting points during the freefall at which a change in accelerometer data is greater than a threshold during a threshold time period, the points indicative of a pipe joint in a drill string of the borehole; and
calculating depth data associated with the data indicative of azimuth and inclination based on the detected points of the borehole survey instrument during the freefall.

11. A method according to claim 8, wherein the borehole survey instrument further comprises a magnetometer and the method further comprises:
continuously recording magnetic data using the magnetometer, as the borehole survey instrument freefalls to the bottom of the borehole;
detecting points during the freefall at which a change in output of the magnetometer is greater than an magnetometer threshold during a threshold time period, the points indicative of a pipe joint in a drill string of the borehole; and
calculating depth data associated with the data indicative of azimuth and inclination based on the detected points of the borehole survey instrument during the freefall.

12. A method according to claim 8, wherein the borehole survey instrument further comprises a pressure sensor, wherein the method further comprises:
continuously recording, as the borehole survey instrument freefalls to the bottom of the borehole, in run pressure data indicative of a pressure of a fluid within the borehole;
continuously recording out run pressure data indicative of the pressure of the fluid within the borehole and collecting out run depth data indicative of depth of the borehole, as the borehole survey instrument is removed from the borehole; and
correlating the out run depth data and out run pressure data with the in run pressure data to provide in run depth data.

13. A borehole survey instrument for collecting borehole survey data indicative of geometry of a borehole and for dropping into the borehole such that the borehole survey instrument freefalls to a bottom of the borehole, the borehole survey instrument comprising:
at least one rate sensor configured to collect data indicative of azimuth of the borehole and an inclination sensor configured to collect data indicative of inclination of the borehole, wherein
the at least one rate sensor and the inclination sensor are configured to continuously measure the azimuth and the inclination as the borehole survey instrument is removed from the borehole.

14. A borehole survey instrument according to claim 13, further comprising a controller, wherein the controller is configured to determine a drift rate of the one or more rate sensors using the output of the at least one rate sensor when the borehole survey instrument is stationary.

15. A borehole survey instrument according to claim 14, wherein the controller is further configured to determine whether the borehole survey instrument is stationary using the output of the at least one rate sensor and the inclination sensor.

16. A borehole survey instrument according to claim 14, wherein the controller is configured to determine the drift rate of the at least one rate sensor without using data collected by the at least one rate sensor by gyrocompassing.

17. A borehole survey instrument according to claim 13, further comprising a pressure sensor configured to collect pressure data indicative of a pressure of a borehole fluid within the borehole, wherein a sensing portion of the pressure sensor is enclosed in a compartment comprising a fluid inlet to expose the pressure sensor to the borehole fluid, and wherein a portion of the pressure sensor comprising electronic components is sealed within a borehole survey instrument housing to prevent ingress of the fluid.

18. A borehole survey instrument according to claim 13, comprising a first rate sensor configured to collect the in run data and the out run data in substantially vertical portions of the borehole and a second rate sensor configured to collect the in run and the out run data in substantially horizontal portions of the borehole.

19. A method for determining a depth of a borehole survey instrument within a borehole, the borehole survey instrument comprising a pressure sensor, an inclination sensor and at least one rate sensor, wherein the borehole survey instrument is configured to collect data on an in run as the borehole survey instrument falls to a bottom of the borehole, and the borehole survey instrument is configured to collect data on an out run as the borehole survey instrument is removed from the borehole during recovery of drill rods of known lengths, the method comprising:
dropping the borehole survey instrument into the borehole, such that the borehole survey instrument freefalls to a bottom of the borehole;
continuously measuring, as the borehole survey instrument freefalls to the bottom of the borehole, in run pressure data indicative of a pressure of a fluid within the borehole, and in run data comprising azimuth data and inclination data indicative of an azimuth and an inclination of the borehole;
continuously measuring during the out run, out run pressure data indicative of the pressure of the fluid within the borehole and out run data comprising azimuth data and inclination data indicative of an azimuth and an inclination of the borehole;
stopping movement of the borehole survey instrument as each drill rod is recovered, and using the known length of each drill rod to derive out run depth data when the borehole survey instrument is stationary; and
correlating the out run depth data and out run pressure data with the in run pressure data to provide in run depth data.

20. A method according to claim 19, wherein at each position in which the out run depth data is derived, an associated out run pressure measurement from the out run pressure data is determined,
and wherein in run pressure measurements equal in value to the associated out run pressure measurements are assigned an in run depth measurement equal to the depth measurement associated with that out run pressure value.
